(19) United States
(12) Patent Application Publication
(10) Pub. No.: US 2025/0251344 A1
(43) Pub. Date: Aug. 7, 2025

(54) SYSTEM AND METHOD FOR INDEFINITE AND BIDIRECTIONAL NEAR INFRARED NANOCRYSTAL PHOTOSWITCHING

(71) Applicants: The Trustees of Columbia University in the City of New York, New York, NY (US); The Regents of the University of California, Oakland, CA (US); Ulsan National Institute of Science and Technology, Ulsan (KR)

(72) Inventors: P. James SCHUCK, New York, NY (US); Changhwan Lee, New York, NY (US); Emma Xu, New York, NY (US); Bruce Cohen, San Francisco, CA (US); Emory Chan, Oakland, CA (US); Yung Doug Suh, Ulsan (KR)

(21) Appl. No.: 19/067,003

(22) Filed: Feb. 28, 2025

Related U.S. Application Data
(63) Continuation of application No. PCT/US2023/031636, filed on Aug. 31, 2023.
(60) Provisional application No. 63/402,759, filed on Aug. 31, 2022.

(51) Int. Cl. G01N 21/64

(52) U.S. Cl. CPC G01N 21/6428; G01N 2021/6432

(57) ABSTRACT

A photo-switchable nanocrystal can be provided which can include solely one or more inorganic elements. Further, a method for synthesizing photo-switchable nanocrystal can be provided which can utilize solely inorganic elements. For example, the fully inorganic element(s) can comprise lanthanide ion (Ln3+)-based phosphors. Further, the nanocrystal can be photostable and/or does not photodegrade with light excitation cycles.

### CROSS REFERENCE TO RELATED APPLICATION(S)

This application relates to and claims the benefit of priority from U.S. Provisional Patent Application No. 63/402,759, filed on Aug. 31, 2022, the entire disclosure of which is incorporated herein by reference in its entirety.

### STATEMENT REGARDING FEDERALLY SPONSORED RESEARCH

This invention was made with government support under DE-NA0003960, DE-SC0019443, and DE-AC02-05CH11231, awarded by the U.S. Department of Energy. The government has certain rights in the invention.

### FIELD OF THE DISCLOSURE

The present disclosure relates to photoswitching inorganic nanocrystals through light excitation, and more specifically to exemplary systems and methods for indefinite and bidirectional near infrared nanocrystal photoswitching.

### BACKGROUND INFORMATION

Materials whose luminescence can be switched by optical stimulation drive technologies can range from superresolution imaging¹⁻⁴, nanophotonics⁵, and optical data storage⁶⁻⁸, to targeted pharmacology, optogenetics, and chemical reactivity⁹. These photoswitchable probes, including organic fluorophores and proteins, may be prone to photodegradation, and often require phototoxic doses of ultraviolet (UV) or visible light. Colloidal inorganic nanoparticles may have stability advantages over existing photoswitchable materials, but the ability to switch emission bidirectionally, particularly with NIR light, has not been reported with nanoparticles.

An important need for better photoswitches is commonly appreciated in the industry. Current photoswitches all rely on labile organic constituents (e.g., fluorescent proteins, organic dyes, molecule-nanocrystal hybrids), which photodegrade and operate at wavelengths that can be phototoxic and are unable to deeply penetrate materials. In his Nobel lecture, W. E. Moerner articulated this challenge, stating that there is a “need for better fluorophores, specifically . . . with the ability to be turned on (and off) at will, with more emitted photons.” Previous work by Stefan Hell had emphasized the potential for “diffraction-unlimited all-optical imaging and writing” enabled by improved bidirectional photoswitches, though the updated probes described there were still organic (Nature 478, 204 (2011)). Going a step further, he alluded to a possible solution while also echoing Moerner's sentiment: “Organic fluorophores . . . have the disadvantage of suffering from bleaching and blinking, making solid-state-based fluorophores very appealing” (see, e.g., Nature Photonics 3, 144 (2009)). Indeed, inorganic solid-state photoswitches (e.g., quantum dots) have frequently been viewed as a potential game-changer in the field. However, decades of development have failed to yield an inorganic fully photoswitchable probe, with researchers instead forced to resort to hybrid constructs that depend on organic functional elements, which suffer the same limitations.

Thus, it may be beneficial to provide an exemplary system and method for indefinite and bidirectional near infrared nanocrystal photoswitching, which can overcome at least some of the deficiencies described herein above.

### SUMMARY OF EXEMPLARY EMBODIMENTS

The following is intended to be a brief summary of the exemplary embodiments of the present disclosure, and is not intended to limit the scope of the exemplary embodiments.

In some exemplary aspects, the exemplary techniques according to the present disclosure relate to a photo-switchable nanocrystal including solely one or more inorganic elements.

In some exemplary aspects, the exemplary techniques according to exemplary embodiments of the present disclosure relate to a nanocrystal, whereas the fully inorganic element(s) can include lanthanide ion (Ln3+)-based phosphors.

In some exemplary aspects, the exemplary techniques according to the exemplary embodiments of the present disclosure relate to a nanocrystal, whereas the nanocrystal can be photostable. According to further exemplary embodiments of the present disclosure, the nanocrystal does not photodegrade with light excitation cycles. According to yet further exemplary embodiments of the present disclosure, the nanocrystal can operate at light wavelengths that are not phototoxic.

According to some exemplary embodiments of the present disclosure, the nanocrystal can be photo-switch emission bidirectionally. In some exemplary embodiments, the bidirectional emission can include a light and a dark nanocrystal state. In other exemplary embodiments, the excitation of the nanocrystal for bidirectional emission can occur at near-infrared light.

In some exemplary aspects, the exemplary techniques according to the exemplary embodiments of the present disclosure relate to a nanocrystal, wherein a first photo-trigger turns the nanocrystal on and a second photo-trigger turns the nanocrystal off. In some exemplary embodiments, the first photo-trigger can be near 700 nm wavelength and the second photo-trigger can be near 1,064 nm wavelength.

In some exemplary aspects, the exemplary techniques according to the exemplary embodiments of the present disclosure can relate to a nanocrystal, wherein the nanocrystal is part of a high-density patterning system. According to further exemplary embodiments of the present disclosure, the high-density patterning system can include brightening and darkening 2D patterns sequentially. According to further exemplary embodiments, the high-density patterning system can include fully-rewritable 3D nanopatterning.

In some exemplary aspects, the exemplary techniques according to the exemplary embodiments of the present disclosure can relate to a nanocrystal, whereas the nanocrystal is part of super-resolution microscopy. According to further exemplary embodiments of the present disclosure, the nanocrystal can be located via the super-resolution microscopy.

In some exemplary aspects, the exemplary techniques according to the exemplary embodiments of the present disclosure relate to a nanocrystal, whereas the light excitation cycles can include at least one thousand cycles.

In some exemplary aspects, the exemplary techniques according to the exemplary embodiments of the present disclosure can relate to a nanocrystal, whereas the nanocrystal does not photodegrade under ambient conditions. According to some exemplary embodiments of the present disclosure, the nanocrystal does not photodegrade under aqueous conditions.

In some exemplary aspects, the exemplary techniques according to the exemplary embodiments of the present disclosure can relate to a nanocrystal, whereas the nanocrystal includes a core/shell NaYF4 ANPs with 8% Tm3+.

In some exemplary aspects, the exemplary techniques according to the exemplary embodiments of the present disclosure can relate to a nanocrystal, whereas the emission can be achieve through photon avalanching.

In some exemplary aspects, the exemplary techniques according to the exemplary embodiments of the present disclosure can relate to a nanocrystal, whereas the inorganic element(s) can include an inorganic crystal that supports photon avalanching.

In some exemplary aspects, the exemplary techniques according to the exemplary embodiments of the present disclosure relate to a nanocrystal, whereas the nanocrystal can be a sub-micron crystal.

In some exemplary aspects, the exemplary techniques according to the exemplary embodiments of the present disclosure relate to a nanocrystal, whereas the nanocrystal can be usable in an anatomical structure and/or an internal unpowered medical product.

In some exemplary aspects, the exemplary techniques according to the exemplary embodiments of the present disclosure can relate to a method for synthesizing photo-switchable nanocrystal which can include utilizing solely inorganic elements.

In some exemplary aspects, the exemplary techniques according to a method of the present disclosure can relate to a nanocrystal, whereas the fully inorganic element(s) can include lanthanide ion (Ln3+)-based phosphors.

In some exemplary aspects, the exemplary techniques according to a method of the present disclosure can relate to a nanocrystal, whereas the nanocrystal can be photostable. According to further exemplary embodiments of the present disclosure, the nanocrystal does not photodegrade with light excitation cycles. According to yet further exemplary embodiments of the present disclosure, the nanocrystal can operate at light wavelengths that are not phototoxic.

According to some exemplary embodiments of a method of the present disclosure, the nanocrystal can photo-switch emission bidirectionally. In some exemplary embodiments, the bidirectional emission can include a light and a dark nanocrystal state. In other exemplary embodiments, the excitation of the nanocrystal for bidirectional emission can occur at near-infrared light.

In some exemplary aspects, the exemplary techniques according to an exemplary method of the present disclosure can relate to a nanocrystal, whereas a first photo-trigger can turn the nanocrystal on and a second photo-trigger turns the nanocrystal off. In some exemplary embodiments according to a method of the present disclosure, the first photo-trigger can be near 700 nm wavelength and the second photo-trigger can be near 1,064 nm wavelength.

In some exemplary aspects, the exemplary techniques according to an exemplary method of the present disclosure can relate to a nanocrystal, whereas the nanocrystal can be part of a high-density patterning system. According to further exemplary embodiments of a method of the present disclosure, the high-density patterning system can include brightening and darkening 2D patterns sequentially. According to further exemplary embodiments, the high-density patterning system can include fully-rewritable 3D nanopatterning.

In some exemplary aspects, the exemplary techniques according to an exemplary method of the present disclosure can relate to a nanocrystal, whereas the nanocrystal can be part of super-resolution microscopy. According to further exemplary embodiments of an exemplary method of the present disclosure, the nanocrystal can be located via the super-resolution microscopy.

In some exemplary aspects, the exemplary techniques according to an exemplary method of the present disclosure can relate to a nanocrystal, whereas the light excitation cycles can includes at least one thousand cycles.

In some exemplary aspects, the exemplary techniques according to an exemplary method of the present disclosure can relate to a nanocrystal, whereas the nanocrystal does not photodegrade under ambient conditions. According to some exemplary embodiments of an exemplary method of the present disclosure, the nanocrystal does not photodegrade under aqueous conditions.

In some exemplary aspects, the exemplary techniques according to an exemplary method of the present disclosure can relate to a nanocrystal, whereas the nanocrystal can include a core/shell NaYF4 ANPs with 8% Tm3+.

In some exemplary aspects, the exemplary techniques according to an exemplary method of the present disclosure can relate to a nanocrystal, whereas the emission can be achieve through photon avalanching.

In some exemplary aspects, the exemplary techniques according to an exemplary method of the present disclosure can relate to a nanocrystal, whereas the inorganic element(s) include any inorganic crystal that supports photon avalanching.

In some exemplary aspects, the exemplary techniques according to a method of the present disclosure relate to a nanocrystal, wherein the nanocrystal is a sub-micron crystal. In some exemplary aspects, the exemplary techniques according to a method of the present disclosure relate to a nanocrystal, wherein the nanocrystal is usable in an anatomical structure.

In some exemplary aspects, the exemplary techniques according to an exemplary method of the present disclosure can relate to a nanocrystal, whereas the nanocrystal can be usable in an anatomical structure.

In some exemplary aspects, the exemplary techniques according to an exemplary method of the present disclosure can relate to a nanocrystal, whereas the nanocrystal can be usable in an internal unpowered medical product.

To that end, it is possible to provide exemplary systems and methods according to exemplary embodiments of the present disclosure, which can facilitate photoswitching of inorganic nanocrystals through light excitation.

According to further exemplary embodiments of the present disclosure, 2-way, near-infrared (NIR) photoswitching of avalanching nanoparticles (ANPs), showing full optical control of upconverted emission using phototriggers in the NIR-I and NIR-II spectral regions useful for subsurface imaging. Employing single-step photodarkening and photobrightening, in some exemplary embodiments of the present disclosure, indefinite photoswitching of individual nanoparticles (e.g., greater than about 1000 cycles over 7 h) can be provided in ambient or aqueous conditions without measurable photodegradation.

These and other objects, features and advantages of the exemplary embodiments of the present disclosure will become apparent upon reading the following detailed description of the exemplary embodiments of the present disclosure, when taken in conjunction with the accompanying claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1A is a schematic diagram of a fully reversible NIR photo-switching response of photon avalanching nanoparticles according to an exemplary embodiment of the present disclosure

FIG. 1B is a graph showing a reversible NIR photoswitching response of photon avalanching nanoparticles according to an exemplary embodiment of the present disclosure;

FIG. 2A is an AFM scanning image of a single and a cluster of 4 avalanching nanoparticles (“ANPs”) (NaYF4: 8% Tm3+@NaY0.8Gd0.2F4, 10 nm core/4 nm shell) according to an exemplary embodiment of the present disclosure;

FIG. 2B is a confocal scanning image of a single and a cluster of 4 ANPs (NaYF4: 8% Tm3+@NaY0.8Gd0.2F4, 10 nm core/4 nm shell) according to an exemplary embodiment of the present disclosure;

FIG. 2C is exemplary luminescence and excitation intensity time-traces of a single ANP according to an exemplary embodiment of the present disclosure;

FIG. 2D is exemplary luminescence and excitation intensity time-traces of a four-ANP cluster according to an exemplary embodiment of the present disclosure;

FIG. 2E is exemplary high-angle annular dark-field scanning transmission electron microscopy (HAADF-STEM, left), differential phase contrast (DPC)-STEM (middle) and magnified NaYF4 unit cell (right) images of an ANP according to an exemplary embodiment of the present disclosure;

FIG. 2F is exemplary time trace showing blinking luminescence from a single 8% Tm3+ 17/6 nm core/shell nanocrystal at Iex=164 kW cm-2 according to an exemplary embodiment of the present disclosure;

FIG. 3A is an exemplary graph illustrating emission intensity versus excitation intensity of a single 8% Tm3+ 17.3/5.6 nm core/shell ANP before and after photodarkening according to an exemplary embodiment of the present disclosure;

FIG. 3B is an exemplary graph illustrating percentage photobrightening recovery of a photodarkened 8% Tm3+ 10.2/4.0 nm core/shell ANP ensemble film sample versus irradiation wavelength according to an exemplary embodiment of the present disclosure;

FIG. 3C is an exemplary graph illustrating percentage recovery versus exposure time and irradiation intensity according to an exemplary embodiment of the present disclosure;

FIG. 3D illustrates potential mechanistic pathways for photodarkening and photobrightening in ANPs according to an exemplary embodiment of the present disclosure;

FIG. 4A is an exemplary graph of time-resolved luminescence and excitation intensities for a single PEG-coated ANP under ambient conditions according to an exemplary embodiment of the present disclosure;

FIG. 4B is an exemplary probability histogram of the average emission intensity of the brightened ANP for 1158 irradiation cycles according to an exemplary embodiment of the present disclosure;

FIG. 4C is an exemplary trace of emission from a single PEG-ANP for a first 70 and a last 25 irradiation cycles according to an exemplary embodiment of the present disclosure;

FIG. 4D is an exemplary rewritable photopatterning of successive crown and face designs in a 100 nm-thick ANP film according to an exemplary embodiment of the present disclosure;

FIG. 4E is a set of exemplary side and top views of a 3D rendered image of a diamond spiral optically patterned into a ˜5 micron-thick ANP film according to an exemplary embodiment of the present disclosure;

FIG. 4F is an exemplary image (left) of spots in a photodarkened 8% Tm3+ ANP film photobrightened with increasing intensities of a 700 nm focused beam (right) according to an exemplary embodiment of the present disclosure;

FIG. 5A is part of a set of exemplary illustrations providing exemplary photoactivated localization microscopy of ANPs, specifically, a 2D histogram of the frame-by-frame localizations of a single 8% Tm3+ ANP (N=403 frames and ANP is photoswitched off and on for each frame) according to an exemplary embodiment of the present disclosure;

FIG. 5B is a set of exemplary illustrations providing exemplary photoactivated localization microscopy of ANPs, specifically, an example of fitting of a 2D Gaussian function to the 2D histogram data in FIG. 5a according to an exemplary embodiment of the present disclosure;

FIG. 5C is a set of exemplary illustrations providing exemplary photoactivated localization microscopy of ANPs, specifically, an illustration of the centroid derived from the 2D Gaussian fit overlaid on a SEM image of the same ANP according to an exemplary embodiment of the present disclosure;

FIG. 5D is a set of exemplary illustrations providing exemplary photoactivated localization microscopy of ANPs, specifically, an exemplary confocal scanning image of a single and a trimer of 8% Tm3+ ANPs according to an exemplary embodiment of the present disclosure;

FIG. 5E is a set of exemplary illustrations providing exemplary photoactivated localization microscopy of ANPs, specifically, an exemplary SEM image of a single and a trimer of 8% Tm3+ ANPs according to an exemplary embodiment of the present disclosure;

FIG. 5F is a set of exemplary illustrations providing exemplary photoactivated localization microscopy of ANPs, specifically, an exemplary image of frame-by-frame localizations of the trimer in e (N=172) according to an exemplary embodiment of the present disclosure;

FIG. 5G is a set of exemplary illustrations providing exemplary photoactivated localization microscopy of ANPs, specifically, an exemplary image of clustering of localizations in FIG. 5f using Gaussian mixture method according to an exemplary embodiment of the present disclosure;

FIG. 5H is a set of exemplary illustrations providing exemplary photoactivated localization microscopy of ANPs, specifically, an exemplary image of fitting of a 2D Gaussian to the 2D-histogram data of the clustered localization in FIG. 5g according to an exemplary embodiment of the present disclosure;

FIG. 5I is a set of exemplary illustrations providing exemplary photoactivated localization microscopy of ANPs, specifically, an exemplary image of the centroids derived from 2D Gaussian fits overlaid on a SEM image of the trimer according to an exemplary embodiment of the present disclosure; and

FIG. 6 is an illustration of an exemplary block diagram of an exemplary system in accordance with certain exemplary embodiments of the present disclosure . . .

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The following description of exemplary embodiments provides non-limiting representative examples referencing numerals to particularly describe features and teachings of different exemplary aspects and exemplary embodiments of the present disclosure. The exemplary embodiments described should be recognized as capable of implementation separately, or in combination, with other exemplary embodiments from the description of the exemplary embodiments. A person of ordinary skill in the art reviewing the description of the exemplary embodiments should be able to learn and understand the different described aspects of the present disclosure. The description of the exemplary embodiments should facilitate understanding of the exemplary embodiments of the present disclosure to such an extent that other implementations, not specifically covered but within the knowledge of a person of skill in the art having read the description of embodiments, would be understood to be consistent with an application of the exemplary embodiments of the present disclosure.

Exemplary embodiments of the present disclosure described herein provide an important solution for at least two longstanding prior limitations that constrain all optical photoswitches, namely poor photostability and phototoxic excitation wavelengths. These optical probes are central to a diverse and important range of technologies including optogenetics, optical data storage, superresolution microscopy, and nanopatterning. Exemplary embodiments disclose systems and methods for creating avalanching upconverting nanoparticles that can be toggled indefinitely between bright and dark states, with different wavelengths of near-infrared (NIR) light in each direction. Exemplary embodiments demonstrate that these nanoparticles can be used for both 3D fully-rewritable nanopatterning, as well as for super-resolution microscopy (so-called IN-PALM, for Indefinite NIR Photon Avalanche Localization Microscopy), which can be capable of sub-nm accuracy and can distinguish individual nanoparticles within clusters.

According to exemplary embodiments of the present disclosure, details of important mechanistic insights can be provided, and unlimited photoswitching can be demonstrated-showing no signs of degradation after thousands of cycles under ambient or aqueous conditions, with profound implications for both fundamental studies and applied technologies. For example, an exemplary spatial resolution in single-molecule localization microscopy (SMLM) techniques is ultimately determined by the number of collected photons; thus, unlimited photoswitching according to exemplary embodiments disclosed herein can provide unlimited resolving power. Further, complete 2-way control of disclosed exemplary embodiments allows researchers to semi-deterministically photoswitch probes as frequently as desired, which alleviates reliance of many SMLM methods on permanent photobleaching or random blinking events and enables dense, all-optical data storage and addressable memory.

According to various exemplary embodiments of the present disclosure, e.g., 2-way, near-infrared (NIR) photoswitching of avalanching nanoparticles (ANPs) can be provided, showing a full optical control of upconverted emission using phototriggers in the NIR-I and NIR-II spectral regions useful for subsurface imaging. For example, employing single-step photodarkening¹⁰⁻¹³ and photobrightening^{12,14-18}, according to some exemplary embodiments, it is possible to demonstrate indefinite photoswitching of individual nanoparticles (e.g., greater than about 1000 cycles over 7 h) in ambient or aqueous conditions without measurable photodegradation.

Various important steps of the photoswitching mechanism can be provided according to exemplary embodiments by, e.g., modeling and/or measuring the photon avalanche properties of single ANPs in both bright and dark states. The exemplary system and method according to the exemplary embodiments of the present disclosure can provide unlimited, reversible photoswitching of ANPs that can facilitate an indefinitely rewritable 2D and 3D multi-level optical patterning of ANPs, as well as optical nanoscopy with sub-Å localization superresolution that allows embodiments to distinguish individual ANPs within tightly packed clusters.

Upconverting nanoparticles (UCNPs) of exemplary embodiments can be lanthanide ion (Ln³⁺)-based phosphors that can convert NIR light to higher energies in the NIR, visible, or UV regions¹⁹⁻²². Unlike organic^{4,23-29}, protein^{26,30,31}, or hybrid organic-inorganic luminescent probes³², UCNPs of exemplary embodiments may not measurably photobleach, even with extended single-particle excitation under ambient conditions^{20,33-35}, or within microlasers under high pump powers^{36,37}. While this exceptional photostability can suggest Ln³⁺-based UCNPs cannot be modulated by light, certain Ln³⁺-based bulk materials have been reported to be susceptible to photodarkening or brightening^{11,38-41}. Based on observations of photodarkening in Tm³⁺-doped fibres^{11,39,41}, as well as studies of color centers and charge traps in UCNPs^{16,17,42,43}, according to various exemplary embodiments of the present disclosure, it is possible to determine if Tm³⁺-doped avalanching nanoparticles (ANPs) can be modulated by light in the same manner. ANPs can be UCNPs with the steepest nonlinear emission response of any nanoscale material^{22,44,45}, which can be facilitated by the exemplary photon avalanching upconversion mechanism.

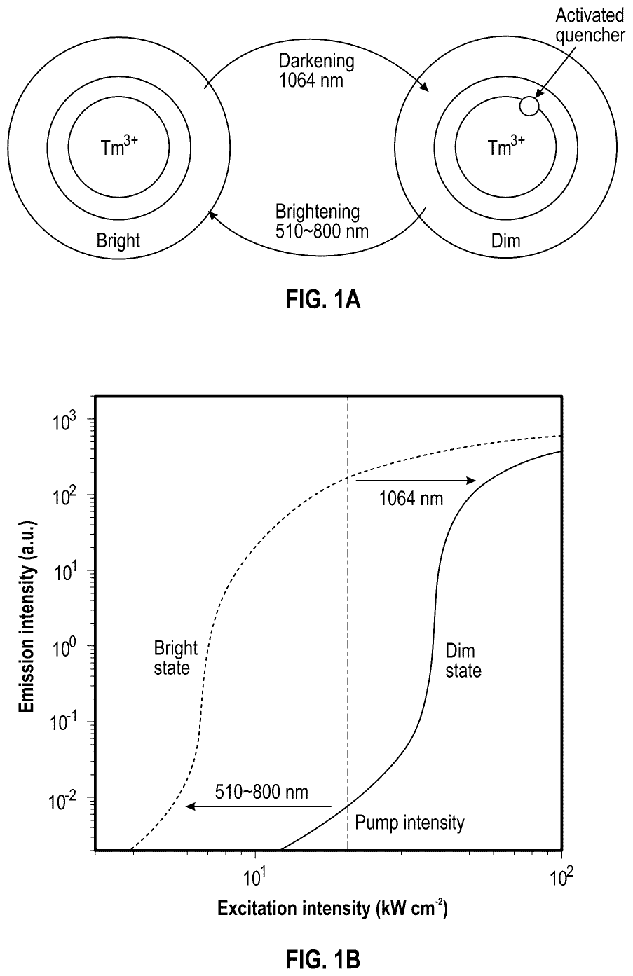

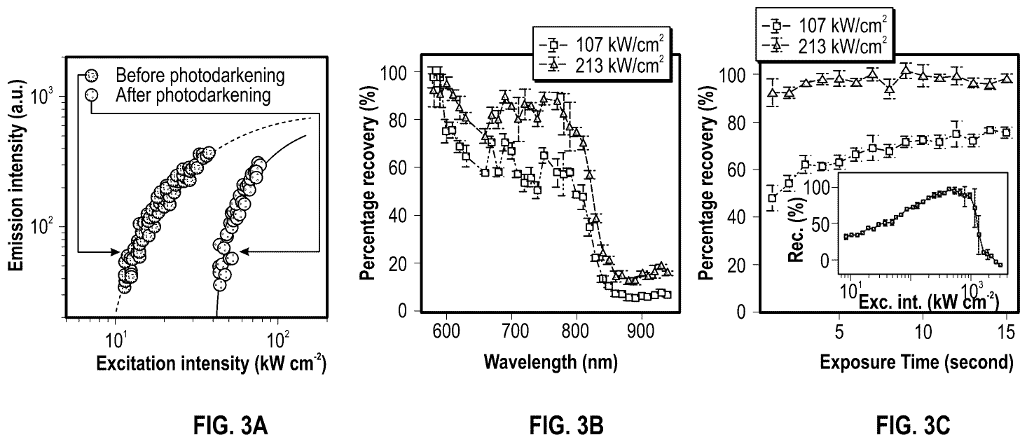

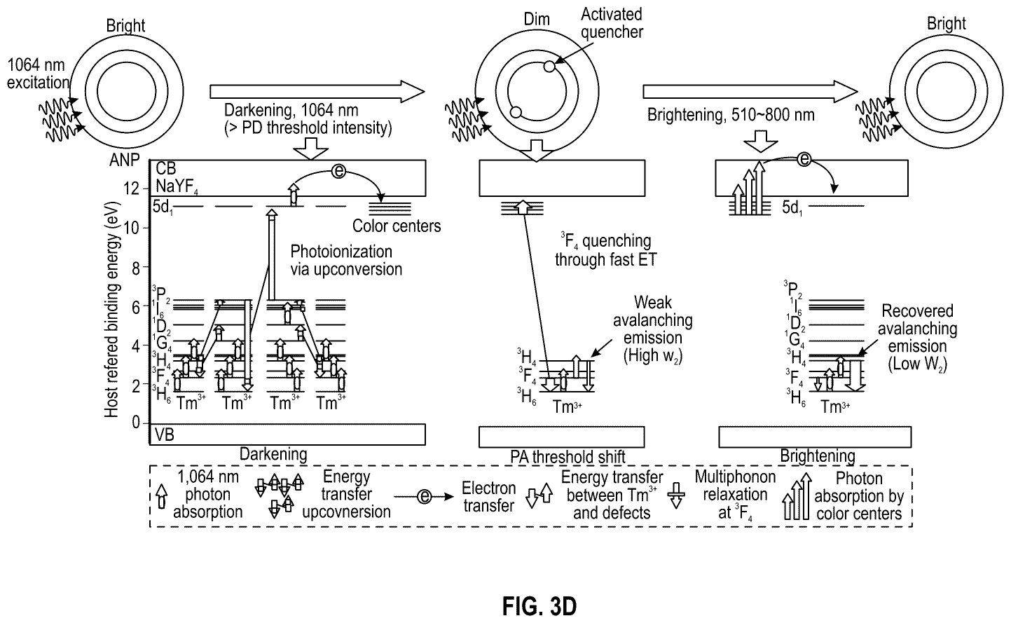

Single-ANP characterization has shown that relatively minor variations in shell thickness lead to sharp changes in avalanche threshold⁴⁶. This can suggest that according to the exemplary embodiments of the present disclosure, light-induced charge or energy transfer within the nanocrystal can also shift the PA threshold, magnifying the influence of a minute density of trap states into major emission differences (see, e.g., FIGS. 1a, 1b, 3a). FIG. 3a shows an exemplary graph illustrating of this phenomenon using 800-nm emission intensity versus 1064-nm excitation intensity of a single 8% Tm3+ 17.3/5.6 nm core/shell ANP before and after photodarkening. Photoswitching between bright and dim states in ANPs for this exemplary graph can be induced by manipulation of the PA threshold, using 1064 nm light to darken and wavelengths ≤800 nm to brighten. The activated quencher 110 of FIG. 1a is a local atomic arrangement, such as a defect, within the nanoparticle that becomes activated when the nanoparticle undergoes intense avalanching. When activated, such an arrangement is capable of shunting energy away from the Tm ions in the nanoparticle and making it more difficult for them to undergo photon avalanching. This can effectively shift the avalanching nanoparticle according to exemplary embodiments from a “bright”, emitting state into a dim state. The quencher can become de-activated using another wavelength of light, thus allowing the nanoparticle to switch back to its bright, emitting state.

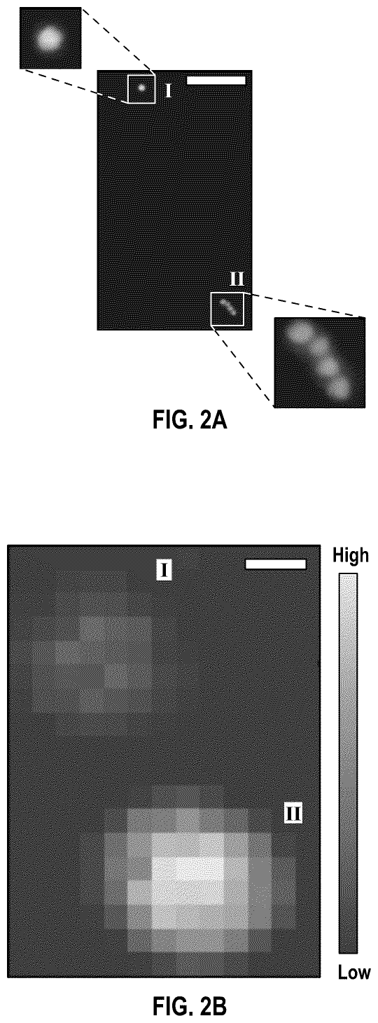

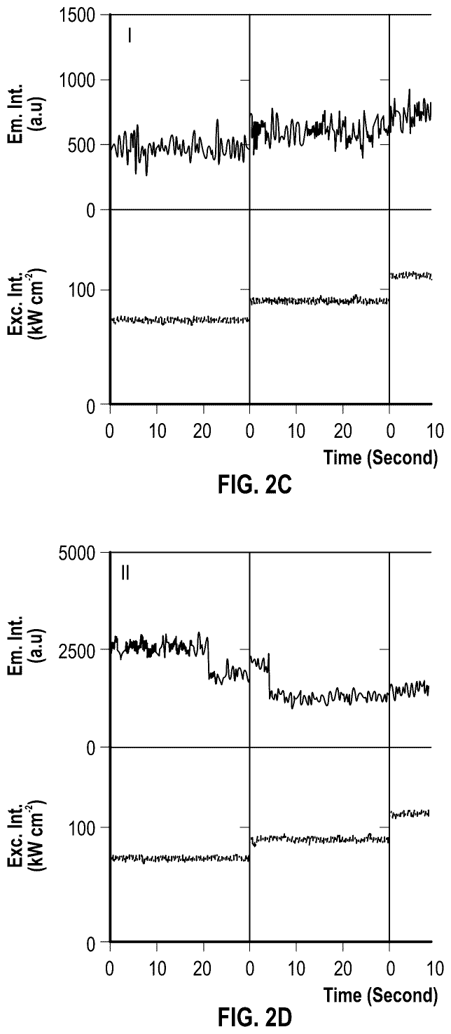

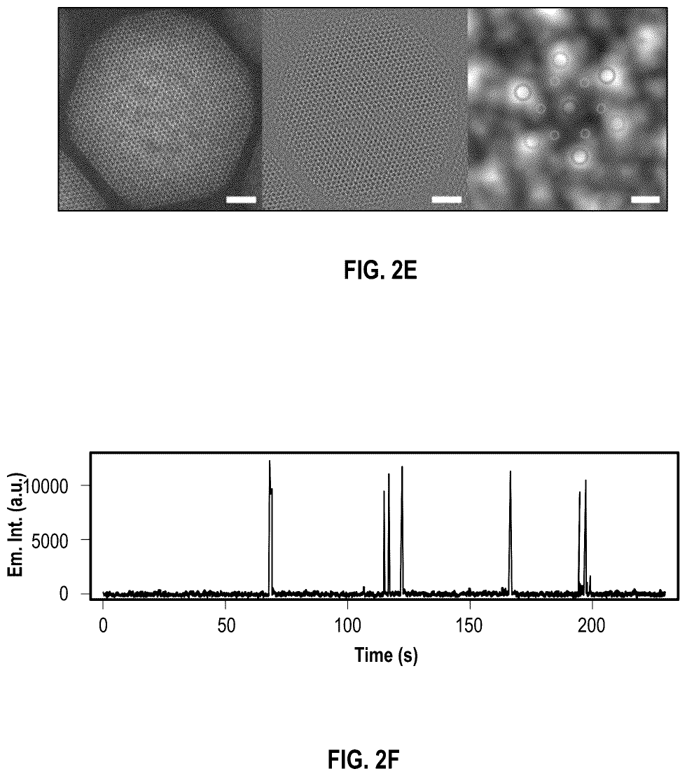

According to various exemplary embodiments of the present disclosure, in order to determine if ANPs are capable of photoswitching, single, core/shell NaYF₄ ANPs with approximately 8% Tm³⁺ under 1064-nm excitation, was characterized at a range of power densities (see FIG. 2). As shown in FIG. 2a, exemplary photodarkening and photoblinking in ANPs are illustrated by AFM for a single ANP 210 and a cluster of four ANPs 220. In FIG. 2b, exemplary photodarkening and photoblinking in ANPs are illustrated by confocal scanning image for a single ANP as well as a cluster of four ANPs 220. By atomic resolution STEM (see FIG. 2e), such exemplary ANPs are pure β-NaYF₄ without any observable extended defects or a clear core/shell interface (e.g., STEM may not observe point defects).

The exemplary system and method according to the exemplary embodiments of the present disclosure can provide that above the avalanching threshold intensity Iₜₕ, the ANPs can exhibit luminescence at 800 nm. As the pump intensity is increased well above Iₜₕ (see FIG. 2), exemplary embodiments reveal that single ANPs darken or blink, exhibiting discontinuous jumps in luminescence (see FIG. 2c,d) within the time-resolution of the exemplary measurement (see Exemplary Methods). According to exemplary embodiments of the present disclosure, the observed single-ANP photoblinking can indicate that the photodarkening process—to date viewed as undesirable but unavoidable in bulk materials—may not be permanent and can be reversed. Photoblinking statistics from single ANPs can show that the blinking is intensity dependent and can be tuned to match desired parameters for some single-molecule localization microscopy (SMLM) applications such as stochastic optical reconstruction microscopy (STORM) imaging (see, e.g., FIG. 2f)⁴.

Additional exemplary measurements in ensemble films of 4% and 8% Tm³⁺ nanocrystals according to exemplary embodiments of the present disclosure, can indicate that photon avalanching (PA) can play a role in the photodarkening. UCNPs doped with ˜4% Tm³⁺, whose nonlinear emission is sub-avalanching (energy looping⁴⁷), may not show the same photodarkening or blinking behavior, at least for excitation intensities up to 2.3 MW cm⁻². When doping is increased to 8% Tm³⁺, the NPs of exemplary embodiments of the present disclosure can exhibit pronounced PA and noticeable photodarkening at excitation intensities ≥143 kW cm⁻² (˜6×Iₜₕ). According to various exemplary embodiments of the present disclosure, the rate of photodarkening can accelerate as pump intensity increases. The ANP photodarkening and blinking can be observed in particles with both thin (2.6 nm) and thick (8.5 nm) inert shells, as well as in ANPs in which passivating oleic acid ligands have been removed, suggesting that surface quenching does not play a major role. Dependence of photodarkening on Ln³⁺ content and pump intensity is consistent with the reported behaviors of Tm³⁺-doped fibers under intense 1064 or 1120 nm excitation^{11,39,41}.

To further understand the origins of the observed ANP behaviors, exemplary embodiments examined the nonlinear emission of single ANPs in both bright and photodarkened states. According to exemplary embodiments, photodarkened nanocrystals continue to exhibit PA emission, but with avalanching threshold intensities Iₜₕ shifted to ˜5-fold higher pump intensities (see, e.g., FIG. 3a). Because of the steeply nonlinear PA process, the luminescence intensity at the same 1064 nm pump intensity can be reduced by, e.g., greater than 4 orders of magnitude following this 5-fold increase in Iₜₕ²². According to various exemplary embodiments of the present disclosure, in such exemplary case, a saturating pumping intensity at first can lead to bright ANP luminescence, although then can shift to weak pre-avalanche luminescence upon the attendant Iₜₕ shift (see FIG. 3a).

According to various exemplary embodiments of the present disclosure, the potential for controllable luminescence recovery can be provided. In exemplary embodiments of the present disclosure, a region of an ANP film with intense 1064 nm pumping can first be photodarkened, then the region can be excited with a laser tunable from 510 nm to 940 nm (Methods). Plots of luminescence recovery versus photobrightening wavelength (see, e.g., FIG. 3b), according to various exemplary embodiments of the present disclosure, show between about, e.g., 10-100% recovery in ANP films, depending on illumination wavelength. In exemplary embodiments, increasing the irradiation intensity also enhances photobrightening (see, e.g., inset in FIG. 3c). The log-log slope of the recovery versus irradiation plot is sublinear according to exemplary embodiments, in sharp contrast to the avalanching emission of these ANPs (e.g., s>20). At more intense photobrightening intensities (>500 kW cm⁻²), additional photodarkening can be ultimately induced (inset in FIG. 3c) in exemplary embodiments, which is also recoverable. These photobrightening parameter studies (see FIG. 3b,c) demonstrate a wide range of control over photoswitching probabilities in the ANPs.

In addition to showing that photoswitching is possible, the photodarkening and photobrightening measurements of exemplary embodiments can provide certain information into the mechanisms at play. Specifically, in addition to the shift in threshold intensity described above (see, e.g., FIGS. 1b and 3a), any mechanism for ANP photoswitching according to exemplary embodiments of the present disclosure can account for the following observations: 1) both the bright and dark states can be stable and show similar steeply non-linear emission; 2) the darkening can be fully reversible, with no measurable long-term degradation in >1000 cycles (see below); 3) the ability to photodarken may be unrelated to factors affecting surface quenching (e.g., surface ligands, water/O₂, or shell thickness); and 4) the brightening step can be possible with a wavelength range much broader than typical for Ln³⁺ excitation. In exemplary embodiments of the present disclosure, the experimental power-dependent emission curves for darkened and undarkened ANPs can be fit to a rate equation model that we previously developed to describe the population balance and the radiative and nonradiative relaxation processes in ANPs²² (see FIG. 3a, dashed lines). Fits to the model according to exemplary embodiments of the present disclosure reveal that, compared to undarkened ANPs, the darkened ANP can have a 5.3-fold faster overall relaxation rate (W₂) from the ³F₄ first excited state of Tm³⁺ (SI). Exemplary embodiments suggest an added, faster, loss of energy from ³F₄.

According to various exemplary embodiments of the present disclosure, taken together, the models and observations can be consistent with a photodarkening scheme in which extended ANP photoexcitation populates high-lying Tm³⁺ excited states (e.g., ¹I₆ and 5d¹4f¹¹ states⁴⁸; see emission spectra due to transitions at the ¹I₆ state) and ultimately results in the transfer of an electron from the Tm³⁺ ion or the neighboring atoms to the NaYF₄ conduction band (see, e.g., FIG. 3d), which is then trapped in a local defect state. FIG. 3d shows an exemplary illustration of potential mechanistic pathways for photodarkening and photobrightening in ANPs where CB stands for “conduction band,” VB stands for “valence band,” and W2 is the 3F4 relaxation rate.

Because the exemplary process, according to various exemplary embodiments of the present disclosure, can be fully reversible (as described herein) and does not involve surface quenching, this charge can be trapped in the interior of the ANP, possibly at the core/shell interface⁴³, where minor defects may arise during synthesis but are not be visible even by high-resolution TEM (see FIG. 2e). Such trap states are capable of quenching the ˜0.7 eV ³F₄ transition of Tm³⁺ via energy transfer^{16,17,43,49}, which may increase W₂ and shift Iₜₕ as observed in exemplary embodiments²² (see, e.g., FIGS. 1b and 3a). Studies of other NP systems have shown that a single trap site can be sufficient to quench luminescence for nanoparticles of similar dimensions as ANPs^{46,50} Several photoionization mechanisms in Tm³⁺-doped glass fibers under NIR excitation have been proposed.^{10,39,41,51}

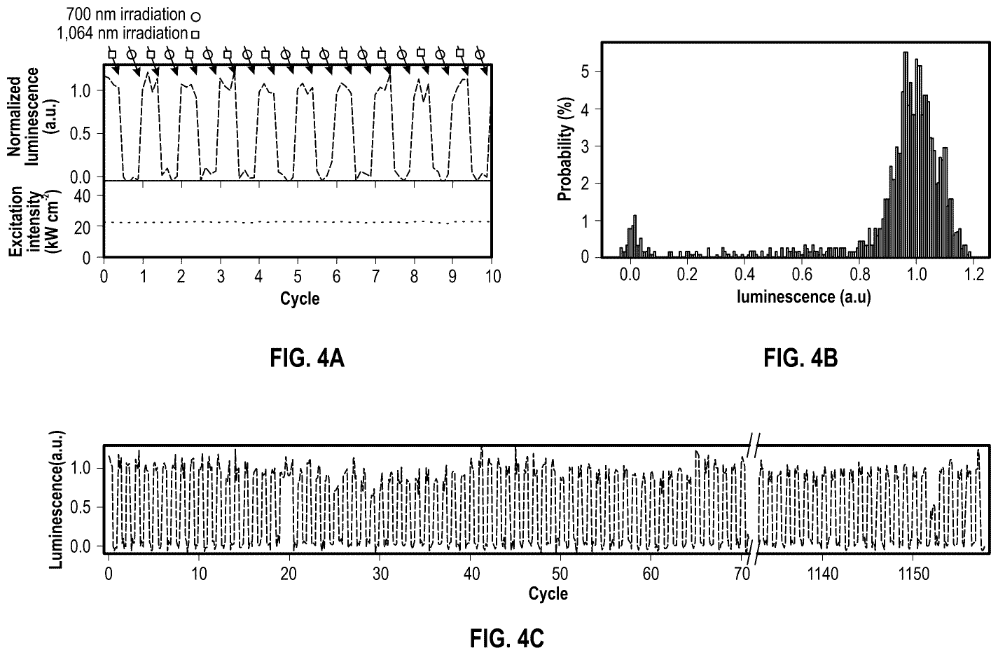

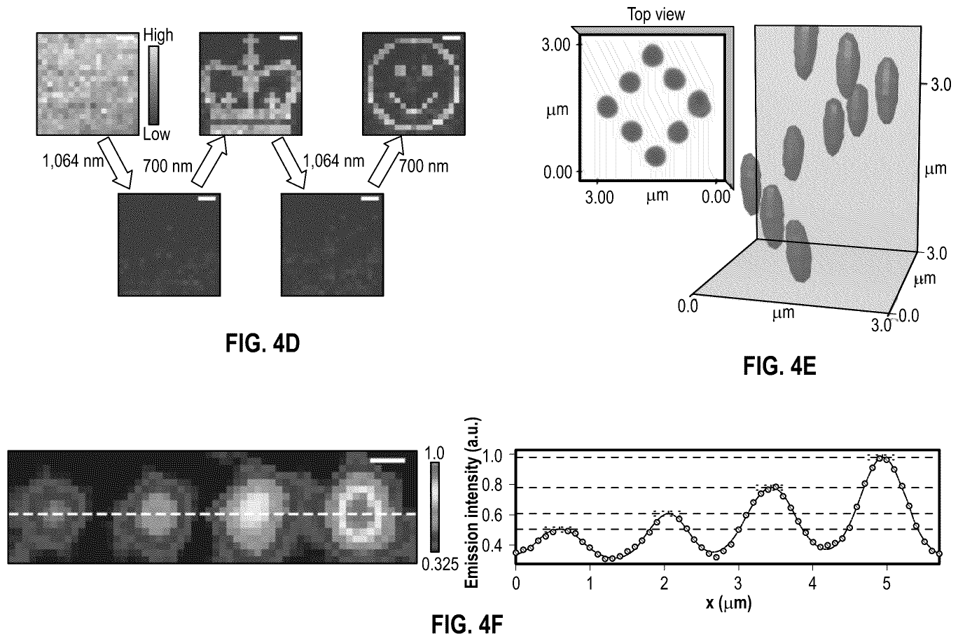

Additionally, according to various exemplary embodiments of the present disclosure, photoswitching behavior can be determined by measuring the emission of single 8% Tm³⁺ core/shell ANPs while sequentially exposing them to repeated cycles of 1064 nm photodarkening followed by 700 nm photobrightening in ambient (see, e.g., FIGS. 4a and 4c) and aqueous environments. The exemplary parameters for the exemplary graphs shown in FIGS. 4a and 4c include a 1064 nm pump intensity of 22.8 kW cm⁻² continuously applied, which can excite a detectable emission in the bright state but not in the dim state. Exemplary irradiation conditions for darkening are 75.5 kW cm⁻² at 1064 nm for 5 seconds and 164.0 kW cm⁻² at 700 nm for 10 seconds for photobrightening.

Successful exemplary photoswitching of a single ANP according to exemplary embodiments of the present disclosure can be observed over 1158 cycles in either ambient or aqueous conditions without any permanent photodegradation (see, e.g., FIG. 4c). A probability histogram of single ANP photoswitching according to exemplary embodiments of the present disclosure can illustrate that emission intensities overwhelmingly return to their original values (see, e.g., FIG. 4b). Partial emission recovery can be occasionally observed (e.g., cycle 1152 shown in FIG. 4c), possibly originating from the involvement of additional trap or defect states^{16,17,43,49}.

To determine if ANP photoswitching can be leveraged in high-density patterning applications⁵², exemplary embodiments leverage a thick (, e.g., about 5 micron) film of approximately 8% Tm³⁺ ANPs that can be deposited onto a glass slide to darken and brighten in sequential 2- and 3-dimensional (2D and 3D) patterns, which can then be imaged by confocal microscopy (see, e.g., FIG. 4d-4e). Rewritable 2D patterns (see, e.g., FIG. 4d) can be created by exemplary embodiments using continuous-wave (CW) 1064 nm and 700 nm focused beams for imaging/darkening and writing, respectively. The 2D patterns shown in FIG. 4d were created, according to exemplary embodiments, by irradiating the applicable pixels in the sample with intensity of 435 kW cm-2 at 1064 nm for 7 seconds for erasing and 164 kW cm-2 at 700 nm for 5 seconds for positive lithography. In exemplary embodiments, the large nonlinearity of PA emission and photodarkening can facilitate patterning resolutions <70 nm²², with potential for exceptionally long storage lifetimes and unlimited read-write cycles due to ANP photostability (see, e.g., FIG. 4c).

Because the low scattering of NIR wavelengths in this process enable subsurface imaging into samples^{47,53}, optical patterning of a complex 3D design ˜3 microns across in all 3 dimensions can be achieved (see, e.g., FIG. 4e). The patterned diamond spiral of an exemplary embodiment shows voxel-to-voxel addressability that expands rewritable functionality beyond the existing thermal reset approach⁵⁴. Furthermore, multiple grayscale levels of 800 nm Tm³⁺ emission can be achieved in an ANP film using varying darkening wavelengths and photon doses, so that a single voxel can host 5 (see, e.g., FIG. 4f) or more levels, expanding density by enabling multi-bit storage per voxel. FIG. 4f shows an exemplary image of spots in a photodarkened 8% Tm3+ ANP film photobrightened with increasing intensities of a 700 nm focused beam. FIG. 4f also provides an exemplary graph illustrating the emission intensities for each spot in the exemplary image.

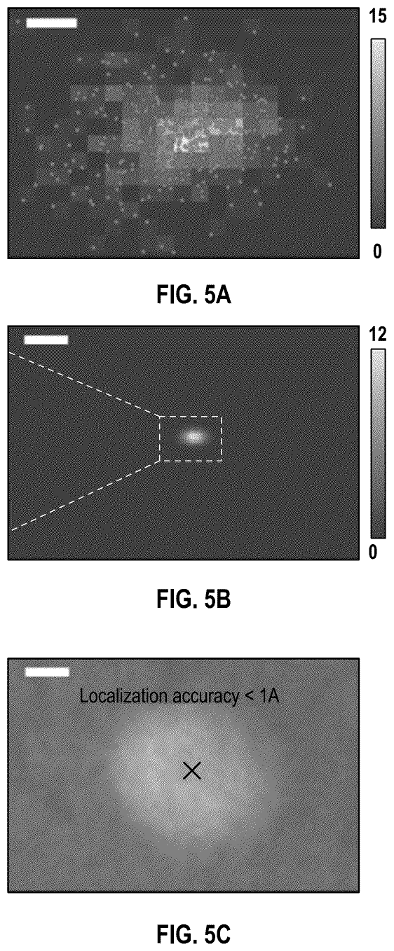

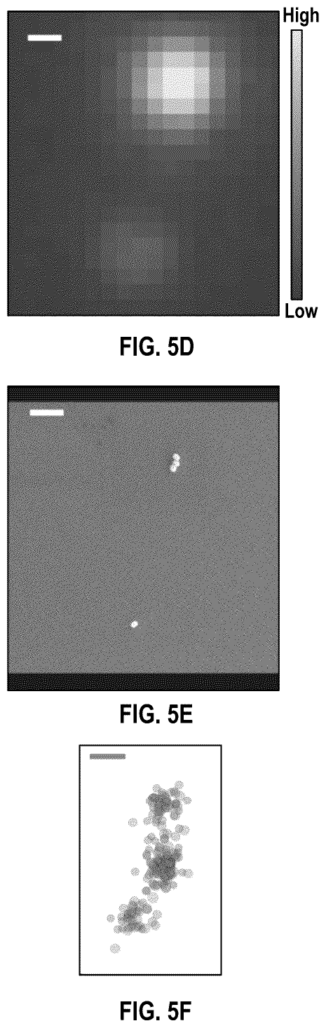

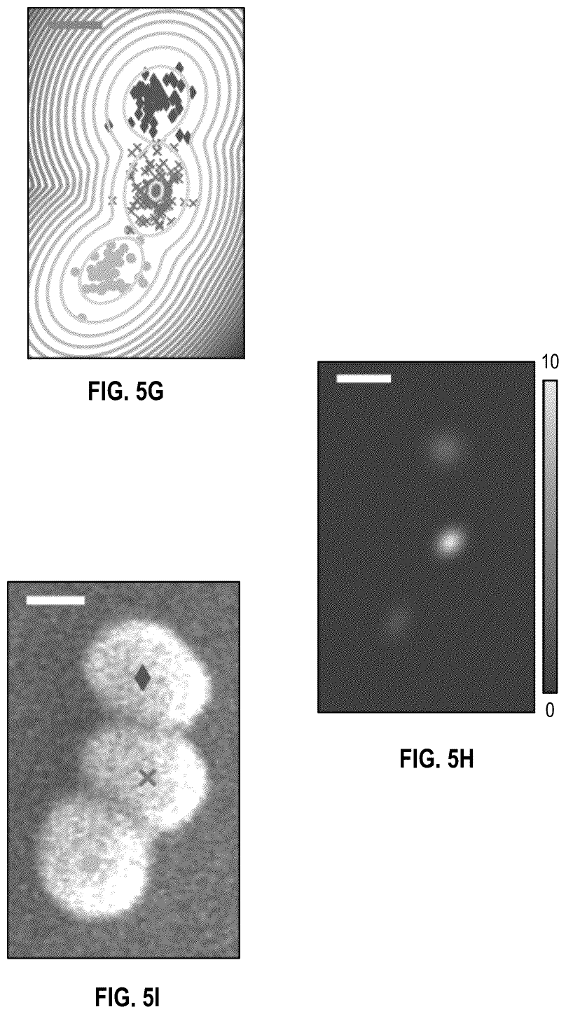

To determine how indefinite ANP photoswitching affects localization accuracies in superresolution microscopy techniques, exemplary embodiments of the present disclosure can utilize indefinite NIR Photon Avalanching Localization Microscopy (IN-PALM) to image single ANPs (see, e.g., FIG. 5a-5e) and ANP clusters (see, e.g., FIGS. 5d and 5e and Exemplary Methods). In exemplary SMLM methods¹, accuracies may be limited by the number of photons collected from an emissive probe before photobleaching^{1,55}. As with photoactivated localization microscopy (PALM)⁵⁶, in IN-PALM, the concentration of emitting ANPs is actively controlled at a very low level. Only a subset of probes can be emissive at a given time, enabling non-overlapping point spread functions of emitted photons to determine precise centroid fittings and localization accuracies. Unlike some SMLM methods where probes are irreversibly photobleached, ANPs according to exemplary embodiments may be brightened and darkened repeatedly, greatly expanding the number of collected photons to improve localization accuracies¹. Acquisition rates provided by the exemplary systems and methods according to various exemplary embodiments of the present disclosure can be determined by, e.g., photobrightening exposure times, which may be power-dependent (see, e.g., FIG. 3c). Thus, a trade-off according to various exemplary embodiments of the present disclosure can exist between exposure time and irradiation intensity, which will depend on sample considerations.

Far-field optical and scanning electron microscopy (SEM) images of a region containing a single 26-nm core/4-nm shell ANP and an ANP trimer (see, e.g., FIGS. 5d and 5e) show, according to an exemplary embodiment of the present disclosure, that individual ANPs in the trimer cannot be resolved optically under wide-field illumination or with confocal scanning (even with the ˜70 nm resolution possible due to the extreme nonlinearity of ANPs²²). Using IN-PALM, diffraction-limited images of the photoactivated ANPs of exemplary embodiments were acquired through repeated photoswitching cycles to reconstruct a super resolved image in which the three touching ANPs are clearly resolved (see, e.g., FIGS. 5f-5i). The high-precision localization is highlighted (see, e.g., FIGS. 5a-5c) with a 2D histogram of the localizations from more than 400 IN-PALM frames on a single ANP (see, e.g., FIG. 5a; the ANP is photoswitched off and on for each frame). In exemplary embodiments, approximately 1.33×10⁸ (or more) total photons can be collected from that ANP without signs of degradation, averaging nearly 330,000 per frame. This can facilitate a fitting of a 2D Gaussian function to the statistics data⁵⁷ (see, e.g., FIG. 5b) and calculation of localization accuracies of 0.98 Å and 0.58 Å in the long and short axis, respectively (see, e.g., FIG. 5c). Further, exemplary methods described herein provide additional data and processing details.

According to various certain exemplary embodiments of the present disclosure, unlimited NIR photoswitching in inorganic ANPs can be provided, showing they are photodarkened under NIR-II irradiation and recover with NIR-I or visible irradiation, with no measurable degradation of ANP emission over >1000 repeated photoswitching cycles under both ambient and aqueous conditions. The key mechanism of photoswitching in ANPs can be a discrete shift of PA threshold intensity. Further, according to certain exemplary embodiments of the present disclosure, superresolution imaging of ANPs can be with sub-Å localization precision, as well as rewritable 2D and 3D multi-hued optical patterning with modest NIR lasers. These exemplary results open new pathways in a variety of applications including, e.g., superresolution imaging^{4,26}, high-density optical memory^{1,8,58-60}, and robust patterning in both 2 and 3 dimensions^{54,61}.

### EXEMPLARY METHODS

### Exemplary Materials

Sodium trifluoroacetate (Na-TFA, 98%), sodium oleate, ammonium fluoride (NH₄F), yttrium chloride (YCl₃, anhydrous, 99.99%), thulium chloride (TmCl₃, anhydrous, 99.9+%), gadolinium chloride (GdCl₃, anhydrous, 99.99%), yttrium trifluoroacetate (99.99+%), oleic acid (OA, 90%), and 1-octadecene (ODE, 90%) were purchased from Sigma-Aldrich.

### Exemplary Synthesis of Core and Core/Shell ANPs

NaY₁₋ₓTmₓF₄ ANP cores with average diameters ranging from d=10 to 18±1 nm can be synthesized, according to exemplary embodiments, based on reported procedures^{47,53}. For X=0.01 (i.e., 1% Tm³⁺ doping), TmCl₃ (0.01 mmol, 2.8 mg) and YCl₃ (0.99 mmol, 193.3 mg) and can be added into a 50 ml 3-neck flask following injection of 6 ml of OA and 14 ml of ODE. The mixture can be stirred under vacuum and heated to 100° C. for 1 h. The solution can be pumped with vacuum and purged with N₂ over three cycles to remove water and oxygen. Subsequently, according to exemplary embodiments, NH₄F (4 mmol, 148 mg) and sodium oleate (2.5 mmol, 762 mg) can be added to the flask with N₂ gas flow. Afterward, in exemplary embodiments, the flask can be resealed and placed under vacuum for 15 min at 100° C., followed by analogous 3 cycles of alternating vacuum pump and N₂ purge for additional 10 min. After that, the solution can be quickly heated to 320° C. (the approximate ramp rate: 25° C./min). The temperature may stay at or near 320° C. for 40-60 min. The exemplary solution can be cooled to room temperature with compressed air.

In various exemplary embodiments of the present disclosure, ethanol can be added to a tube containing the ANPs and the nanocrystals can be separated by centrifugation for 5 min at 4000 rpm. The dispersion with suspended pellets can be additionally centrifuged to remove large aggregated particles. The nanoparticles, according to various exemplary embodiments of the present disclosure, can be purified by a combination of ethanol wash, centrifuging, and pellet dissolution in hexane. The whole cycle may be repeated one more time to further purify the nanocrystals. The nanocrystals of exemplary embodiments of the present disclosure can be stored in hexane with two drops of OA to prevent aggregation.

### Exemplary Shell Growth

A 0.1 M stock solution of 20% GdCl₃ and 80% YCl₃ can prepared in accordance with exemplary embodiments by mixing YCl₃ (2 mmol, 390.5 mg), GdCl₃ (0.5 mmol, 131.8 mg), 10 ml OA and 15 ml ODE in a 50 ml 3-neck flask. The mixture can be stirred under vacuum and heated to 110° C. for 30 min. The flask can be filled with N₂ gas and heated to 200° C. for about 1 h, until the solution becomes clear, and no solid is visible in the solution. The solution of exemplary embodiments can be cooled to 100° C. and placed under vacuum for 30 min. A 0.2 M solution of Na-TFA can be prepared per exemplary embodiments by mixing Na-TFA (4 mmol, 544 mg), 10 ml OA and 10 ml ODE in a flask, under vacuum, at room temperature for 2 h to ensure that all chemicals are dissolved. 3-9 nm NaY_{0.8}Gd_{0.2}F4 shells can be grown according to exemplary embodiments of the present disclosure on ANP cores using a layer-by-layer protocol⁶² inside a nitrogen-filled glovebox containing Workstation for Automated Nanocrystal Discovery and Analysis (WANDA)⁶².

In certain exemplary embodiments of the present disclosure, for a 3 nm shell thickness, 6 mL ODE and 4 mL OA can be injected to the dried ANP cores and heated to 280° C. at 20° C./min in the WANDA glove box. a 0.2 M Na-TFA stock solution and a 0.1 M stock solution of 20% Gd and 80% Y oleate solution can be added alternatively according to the automated protocols. Each alternating injection cycle of exemplary embodiments can be performed every 40 minutes (e.g., one injection every 20 minutes) over 6 repeated cycles. After the last injection of each cycle, it can be annealed at 280° C. for an additional 30 minutes. After that, it can be cooled rapidly by N₂ gas flow. The core-shell particles of exemplary embodiments can be separated and purified using an identical purification protocol described above.

Core-shell NaYF₄ nanocrystals with varying Tm³⁺ concentrations (from, e.g., 1 to 100%) can be fabricated according to exemplary embodiments using analogous protocols.

### Exemplary Nanoparticle Characterization

Transmission electron microscopy (TEM) according to exemplary embodiments of the present disclosure can be achieved using a JEOL JEM-2100F field emission TEM operating at an acceleration voltage of 200 kV, FEI Themis 60-300 STEM/TEM at an acceleration voltage of 300 kV and Tecnai T20 S-TWIN TEM at 200 kV with a LaB6 filament. The statistics of the nanocrystal sizes can be calculated based on the size of approximately 100 nanoparticles using ImageJ software. X-Ray diffraction (XRD) measurement according to various exemplary embodiments of the present disclosure can be performed using a Bruker D8 Discover diffractometer with Cu Kα radiation.

High-resolution STEM images can be acquired on an aberration corrected Titan 80-300 called TEAM 0.5 at the Molecular Foundry. According to various exemplary embodiments of the present disclosure, the microscope may be operated at 200 kV with a convergence semi-angle of 17 mrad and approximately 5 pA beam current. The 4D Camera per exemplary embodiments can be used to acquire a series of diffraction patterns from a grid of 1024×1024 probe positions with real space step size of 40 μm and acquisition time of 11 microseconds. The center of mass of each diffraction pattern may be calculated and then used to estimate the phase of the electron beam by the differential phase contrast technique. Each algorithm can be implemented in the open source stempy package. The phase can be much more sensitive to weakly scattering atoms such as Fluorine compared to the Z-contrast of the annular dark field signal. This facilitated for the exemplary systems and methods according to the exemplary embodiments of the present disclosure to image the atomic structure of beam sensitive ANPs to confirm they do not contain large scale defects.

### Exemplary Preparation of Nanocrystal Film Samples

To prepare film samples usable for the systems, methods and materials according to various exemplary embodiments of the present disclosure, nanocrystals in approximately 40 μL suspension with a concentration of about 1 μM can be either drop-casted or spin-coated on a coverslip. AFM measurements (Bruker Dimension AFM) can be performed to measure the film thickness of the prepared films.

### Exemplary Optical Characterization of ANPs

For confocal microscopy of ANPs of exemplary embodiments, an inverted confocal microscope (Nikon, Eclipse Ti-S) fitted with a 3D (XYZ) nanoscanning piezo stage (Physik Instrumente, P-545.xR8S Plano) can be used. Single particles deposited on glass coverslips can be excited with a 1064-nm continuous-wave diode laser (Thorlabs, M9-A64-0300). A 950 nm long-pass filter (Thorlabs, FELH 950) and 950 nm short-pass dichroic mirror (Thorlabs, DMSP 950) can be placed on the excitation beam path to filter out all the wavelengths above 950 nm. In exemplary embodiments, an 850 nm short-pass filter (Thorlabs, FESH 850) and a 750 nm long-pass filter (Thorlabs, FELH 750) can be used to selectively collect the 800 nm photons from the sample. A 1.49NA 100× immersion oil objective (Olympus) and a 0.95NA 100× air objective lens (Nikon) can be used in exemplary embodiments for the imaging of single ANPs and ANP ensembles, respectively. Emitted light can be directed to an electron-multiplying charge-coupled device (EMCCD)-equipped spectrometer (Princeton Instruments, ProEM: 1600² eXcelon™ 3) or a single-photon avalanche diode (Micro Photon Device, PDM series) in accordance with exemplary embodiments of the present disclosure.

A neutral density wheel with a continuously variable density (Newport, 100FS04DV.4) can be synchronized with the collection system and automatically rotated by an Arduino-controlled rotator to perform power dependence measurements in exemplary embodiments. A Thorlabs power meter (PM100D and S120VC) can simultaneously record the ˜10% of the laser power reflected by a glass coverslip. In certain exemplary embodiments of the present disclosure, average excitation power densities can be estimated using measured laser powers on the sample plane converted by the recorded laser power by the power meter and using the area calculated from the FWHM of the imaged laser spot.

### Exemplary Time-Tagged Time-Resolved (TTTR) Luminescence

For time-resolved luminescence experiment according to exemplary embodiments, a time-correlated single-photon counting (TCSPC) device (e.g., Picoquant, Hydraharp 400) coupled to a single-photon avalanche diode can be used to record the timing data of detected photons. Time-Tagged Time-Resolved (TTTR) luminescence of ANP ensembles can be measured by detecting single photons and recording the arrival time relative to the beginning of the exemplary measurement.

Exemplary Photoswitching of ANP Ensemble Films with Two Lasers

In various exemplary embodiments of the present disclosure, illumination at 1064 nm and 510-950 nm from a 1064-nm continuous-wave diode laser (Thorlabs, M9-A64-0300), and a Ti-sapphire pulsed laser (Coherent, Chameleon OPO Vis, 80 MHz) or a 532 nm continuous-wave laser (Coherent, Sapphire CDRH) can be focused on the ANPs on the inverted confocal microscope to investigate the photoswitching properties of ANP ensembles. A 950 nm short-pass dichroic mirror (Thorlabs, DMSP950R) can be placed in the excitation beam path to merge two laser beams for photodarkening and photobrightening. The alignment of two laser beams at the sample plane in exemplary embodiments can be confirmed by measuring the beam images on a CMOS camera (Amscope, MU503) that can be installed on a side port of the inverted microscope. In exemplary embodiments, the timing of the two illuminations can be programmed by Scopefoundry, a custom python-based software, which controls the two dual-position sliders (Thorlabs, ELL6).

### Exemplary Correlative Light and Electron Microscopy for Indefinite NIR Photon Avalanching Localization Microscopy (IN-PALM)

In exemplary embodiments of the present disclosure, the single ANPs on a glass coverslip marked by a finder grid (Gilder Grids, G200F1-C3) can be placed on an inverted microscope (Nikon, Eclipse Ti2000-U). Wide-field illumination from a 1064-nm continuous-wave diode laser (3SP Technologies, 1064CHP) and focused illumination from a 532 nm continuous-wave laser (Cobolt, Samba 50 mW) can be directed on the sample through a 1.4NA 50× immersion oil objective (Nikon, PLAN APO 60×). The two-color illuminations can be alternated, per exemplary embodiments, using two stepper motors which open and close a beam block on the signal of an Arduino board controlled by a python-based program (Scopefoundry). According to exemplary embodiments, in order to shift from 1064 nm illumination for imaging to that for photodarkening, the beam size of the wide-field illumination can be changed using a motorized flipper (Newport, 8892-K-M) in which a plano-convex lens (Thorlabs, AC254-400) can be mounted. The 1064 nm excitation intensities for imaging and photodarkening are 58.7 kW cm-2 and 559 kW cm-2, respectively. The 532 nm excitation intensity for photobrightening is 842 kW cm-2. The probability of the photobrightening occurrence is governed by the statistical distribution. The exposure times for darkening and brightening can be set to 2 and 8 sec, respectively. The samples under 1064 nm excitation for exemplary embodiments can be imaged by an EMCCD camera (Andor, iXon DU-888D-C00-#BV). The EM gain and the exposure time of the camera can be set to 300 and 1 sec, respectively. In exemplary embodiments, the scanning electron microscopy can be performed using 10 kV SEM (Carl Zeiss, SigmaHD) after the sample is coated with platinum for 120 s using a sputter coater (Cressington, 108).

### Exemplary Data Processing for IN-PALM

To reconstruct and quantify IN-PALM images, exemplary embodiments can estimate the centroid of PSFs using a 2D-gaussian fitting. The fitting of 2D-gaussian function to the wide-field image frames offers the collection of the PSF centroids dispersed along with the drift of the sample. The drift correction in exemplary embodiments can be achieved by using reference particle images which are not photoswitched during IN-PALM imaging. The PSFs of the 6 ANPs collected during the fitting can be used to correct the lateral and rotational drift of the sample, yielding centroid clusters within 20 nm. The 2D histograms of the centroid clusters (see FIG. 5a; ANP is photoswitched off and on for each frame) can allow for the further fitting of 2D-gaussian function to the statistic images (see FIG. 5b) which may provide the centroid positions and the localization accuracies of the ANP clusters according to exemplary embodiments of the present disclosure.

In exemplary embodiments of the present disclosure, data-processing using a Gaussian mixture method can offer a way to separate a mixture of localizations into several groups (see, e.g., FIGS. 5f and 5g)⁶³. FIG. 5h shows an exemplary illustration of fitting of a 2D Gaussian to the 2D-histogram data of the clustered localization in FIG. 5g, and FIG. 5i s illustrates the centroids derived from the 2D Gaussian fits overlaid on a SEM image of the trimer. Further, the near-uniform brightness of each ANP according to exemplary embodiments of the present disclosure proves beneficial, facilitating the use of a simple intensity filter to reject frames that include more than one brightened ANP within a cluster, eliminating another source of error. In rare instances according to exemplary embodiments of the present disclosure, more than one particle may partially photobrighten, resulting in erroneous position localization estimates.

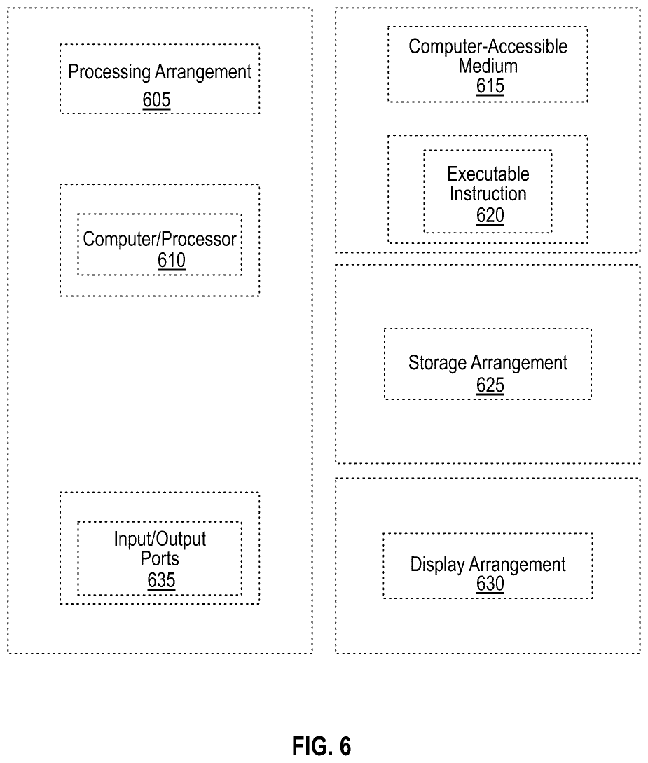

FIG. 6 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 605. Such processing/computing arrangement 605 can be, for example entirely or a part of, or include, but not limited to, a computer/processor 610 that can include, for example one or more microprocessors, and use instructions stored on a computer-accessible medium (e.g., RAM, ROM, hard drive, or other storage device).

As shown in FIG. 6, for example a computer-accessible medium 615 (e.g., as described herein above, a storage device such as a hard disk, floppy disk, memory stick, CD-ROM, RAM, ROM, etc., or a collection thereof) can be provided (e.g., in communication with the processing arrangement 605). The computer-accessible medium 615 can contain executable instructions 620 thereon. In addition or alternatively, a storage arrangement 625 can be provided separately from the computer-accessible medium 615, which can provide the instructions to the processing arrangement 605 so as to configure the processing arrangement to execute certain exemplary procedures, processes, and methods, as described herein above, for example. Further, the exemplary processing arrangement 605 can be provided with or include an input/output ports 635, which can include, for example a wired network, a wireless network, the internet, an intranet, a data collection probe, a sensor, etc. As shown in FIG. 6, the exemplary processing arrangement 605 can be in communication with an exemplary display arrangement 630, which, according to certain exemplary embodiments of the present disclosure, can be a touch-screen configured for inputting information to the processing arrangement in addition to outputting information from the processing arrangement, for example. Further, the exemplary display arrangement 630 and/or a storage arrangement 625 can be used to display and/or store data in a user-accessible format and/or user-readable format.

According to exemplary embodiments of the present disclosure, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one exemplary embodiment,” or “in one implementation” does not necessarily refer to the same example, exemplary embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification and drawings, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### EXEMPLARY REFERENCES

The following references are hereby incorporated by reference, in their entireties:
1 Moerner, W. E. Single-molecule spectroscopy, imaging, and photocontrol: foundations for super-resolution microscopy (nobel lecture). Angewandte Chemie International Edition 54, 8067-8093 (2015).
2 Keller, J., Schönle, A. & Hell, S. W. Efficient fluorescence inhibition patterns for RESOLFT microscopy. Optics express 15, 3361-3371 (2007).
3 Heilemann, M. et al. Subdiffraction-resolution fluorescence imaging with conventional fluorescent probes. Angewandte Chemie International Edition 47, 6172-6176 (2008).
4 Dempsey, G. T., Vaughan, J. C., Chen, K. H., Bates, M. & Zhuang, X. Evaluation of fluorophores for optimal performance in localization-based super-resolution imaging. Nature methods 8, 1027-1036 (2011).
5 Hou, L. et al. Optically switchable organic light-emitting transistors. Nature nanotechnology 14, 347-353 (2019).
6 Waldermann, F. et al. Creating diamond color centers for quantum optical applications. Diamond and Related Materials 16, 1887-1895 (2007).
7 Dhomkar, S., Henshaw, J., Jayakumar, H. & Meriles, C. A. Long-term data storage in diamond. Science advances 2, e1600911 (2016).
8 Gu, M., Zhang, Q. & Lamon, S. Nanomaterials for optical data storage. Nature Reviews Materials 1, 1-14 (2016).
9 Velema, W. A., Szymanski, W. & Feringa, B. L. Photopharmacology: beyond proof of principle. Journal of the American Chemical Society 136, 2178-2191 (2014).
10 Barber, P., Paschotta, R., Tropper, A. & Hanna, D. Infrared-induced photodarkening in Tm-doped fluoride fibers. Optics letters 20, 2195-2197 (1995).
11 Laperle, P., Chandonnet, A. & Vallée, R. Photoinduced absorption in thulium-doped ZBLAN fibers. Optics letters 20, 2484-2486 (1995).
12 Booth, I. J., Archambault, J.-L. & Ventrudo, B. F. Photodegradation of near-infrared-pumped Tm³⁺-doped ZBLAN fiber upconversion lasers. Optics letters 21, 348-350 (1996).
13 Liu, Y. et al. Thermal bleaching of photodarkening and heat-induced loss and spectral broadening in Tm³⁺-doped fibers. Optics Express 28, 21845-21853 (2020).
14 Qin, G. et al. Photodegradation and photocuring in the operation of a blue upconversion fiber laser. Journal of Applied Physics 97, 126108, doi: 10.1063/1.1943513 (2005).
15 Xing, Y.-b. et al. Active radiation hardening of Tm-doped silica fiber based on pump bleaching. Optics express 23, 24236-24245 (2015).
16 Hu, Y. et al. X-ray-Excited Super-Long Green Persistent Luminescence from Tb³⁺ Monodoped β-NaYF₄. The Journal of Physical Chemistry C 124, 24940-24948 (2020).
17 Ou, X. et al. High-resolution X-ray luminescence extension imaging. Nature 590, 410-415 (2021).
18 Qin, G. et al. (American Institute of Physics, 2005).
19 Chan, E. M., Levy, E. S. & Cohen, B. E. Rationally designed energy transfer in upconverting nanoparticles. Advanced Materials 27, 5753-5761 (2015).
20 Wu, S. et al. Non-blinking and photostable upconverted luminescence from single lanthanide-doped nanocrystals. Proceedings of the National Academy of Sciences 106, 10917-10921 (2009).
21 Wen, S. et al. Future and challenges for hybrid upconversion nanosystems. Nature Photonics 13, 828-838 (2019).
22 Lee, C. et al. Giant nonlinear optical responses from photon-avalanching nanoparticles. Nature 589, 230-235 (2021).
23 Müller, T., Schumann, C. & Kraegeloh, A. STED microscopy and its applications: new insights into cellular processes on the nanoscale. ChemPhysChem 13, 1986-2000 (2012).
24 Lukinavičius, G. et al. A near-infrared fluorophore for live-cell super-resolution microscopy of cellular proteins. Nature chemistry 5, 132-139 (2013).
25 Dempsey, G. T., Vaughan, J. C., Chen, K. H., Bates, M. & Zhuang, X. Evaluation of fluorophores for optimal performance in localization-based super-resolution imaging. Nature methods 8, 1027 (2011).
26 Chozinski, T. J., Gagnon, L. A. & Vaughan, J. C. Twinkle, twinkle little star: photoswitchable fluorophores for super-resolution imaging. FEBS letters 588, 3603-3612 (2014).
27 Berkovic, G., Krongauz, V. & Weiss, V. Spiropyrans and spirooxazines for memories and switches. Chemical reviews 100, 1741-1754 (2000).
28 Irie, M. Diarylethenes for memories and switches. Chemical Reviews 100, 1685-1716 (2000).
29 Beharry, A. A. & Woolley, G. A. Azobenzene photoswitches for biomolecules. Chemical Society Reviews 40, 4422-4437 (2011).
30 Brakemann, T. et al. A reversibly photoswitchable GFP-like protein with fluorescence excitation decoupled from switching. Nature biotechnology 29, 942-947 (2011).
31 Dickson, R. M., Cubitt, A. B., Tsien, R. Y. & Moerner, W. E. On/off blinking and switching behaviour of single molecules of green fluorescent protein. Nature 388, 355-358 (1997).
32 Erno, Z., Yildiz, I., Gorodetsky, B., Raymo, F. M. & Branda, N. R. Optical control of quantum dot luminescence via photoisomerization of a surface-coordinated, cationic dithienylethene. Photochemical & Photobiological Sciences 9, 249-253 (2010).
33 Park, Y. I. et al. Nonblinking and nonbleaching upconverting nanoparticles as an optical imaging nanoprobe and T1 magnetic resonance imaging contrast agent. Advanced Materials 21, 4467-4471 (2009).
34 Nam, S. H. et al. Long-term real-time tracking of lanthanide ion doped upconverting nanoparticles in living cells. Angewandte Chemie International Edition 50, 6093-6097 (2011).
35 Gargas, D. J. et al. Engineering bright sub-10-nm upconverting nanocrystals for single-molecule imaging. Nature nanotechnology 9, 300-305 (2014).
36 Fernandez-Bravo, A. et al. Continuous-wave upconverting nanoparticle microlasers. Nature nanotechnology 13, 572-577 (2018).
37 Fernandez-Bravo, A. et al. Ultralow-threshold, continuous-wave upconverting lasing from subwavelength plasmons. Nature materials 18, 1172-1176 (2019).
38 Akhmetov, S., Akhmetova, G., Kolodiev, B. & Samojlovich, M. Optical absorption spectra of YAG (Eu²⁺, Eu³⁺) and YAG (Yb²⁺, Yb³⁺) crystals. Zhurnal Prikladnoj Spektroskopii 48, 681-683 (1988).
39 Broer, M., Krol, D. & DiGiovanni, D. Highly nonlinear near-resonant photodarkening in a thulium-doped aluminosilicate glass fiber. Optics letters 18, 799-801 (1993).
40 Engholm, M. & Norin, L. Preventing photodarkening in ytterbium-doped high power fiber lasers; correlation to the UV-transparency of the core glass. Optics Express 16, 1260-1268 (2008).
41 Lupi, J.-F. et al. Steady photodarkening of thulium alumino-silicate fibers pumped at 1.07 μm: quantitative effect of lanthanum, cerium, and thulium. Optics letters 41, 2771-2774 (2016).
42 Zhuang, Y. et al. X-ray-charged bright persistent luminescence in NaYF₄: Ln³⁺@NaYF₄ nanoparticles for multidimensional optical information storage. Light: Science & Applications 10, 1-10 (2021).
43 Qin, X. et al. Suppression of Defect-Induced Quenching via Chemical Potential Tuning: A Theoretical Solution for Enhancing Lanthanide Luminescence. The Journal of Physical Chemistry C 123, 11151-11161 (2019).
44 Liang, Y. et al. Migrating photon avalanche in different emitters at the nanoscale enables 46th-order optical nonlinearity. Nature Nanotechnology, 1-7 (2022).
45 Bednarkiewicz, A., Chan, E. M., Kotulska, A., Marciniak, L. & Prorok, K. Photon avalanche in lanthanide doped nanoparticles for biomedical applications: super-resolution imaging. Nanoscale Horizons (2019).
46 Kwock, K. W. et al. Surface-Sensitive Photon Avalanche Behavior Revealed by Single-Avalanching-Nanoparticle Imaging. The Journal of Physical Chemistry C 125, 23976-23982 (2021).
47 Levy, E. S. et al. Energy-looping nanoparticles: harnessing excited-state absorption for deep-tissue imaging. ACS nano 10, 8423-8433 (2016).
48 Qin, X., Liu, X., Huang, W., Bettinelli, M. & Liu, X. Lanthanide-activated phosphors based on 4f-5d optical transitions: theoretical and experimental aspects. Chemical reviews 117, 4488-4527 (2017).
49 Narasimha Reddy, K. & Subba Rao, U. High-temperature X-ray irradiation induced thermoluminescence and half-life calculations in NaYF₄ polycrystalline samples. Crystal Research and Technology 19, 1399-1403 (1984).
50 Zhang, Y., Lei, P., Zhu, X. & Zhang, Y. Full shell coating or cation exchange enhances luminescence. Nature communications 12, 1-10 (2021).
51 Chandonnet, A., Laperle, P., LaRochelle, S. & Vallée, R. in Photosensitive Optical Materials and Devices. 70-81 (SPIE).
52 Ren, Y. et al. Reversible upconversion luminescence modification based on photochromism in BaMgSiO₄: Yb³⁺, Tb³⁺ ceramics for anti-counterfeiting applications. Advanced Optical Materials 7, 1900213 (2019).
53 Tian, B. et al. Low irradiance multiphoton imaging with alloyed lanthanide nanocrystals. Nature communications 9, 1-8 (2018).
54 Hu, Z. et al. Reversible 3D optical data storage and information encryption in photo-modulated transparent glass medium. Light: Science & Applications 10, 1-9 (2021).
55 Thompson, M. A., Lew, M. D. & Moerner, W. Extending microscopic resolution with single-molecule imaging and active control. Annual review of biophysics 41, 321-342 (2012).
56 Betzig, E. et al. Imaging intracellular fluorescent proteins at nanometer resolution. science 313, 1642-1645 (2006).
57 Cnossen, J. et al. Localization microscopy at doubled precision with patterned illumination. Nature methods 17, 59-63 (2020).
58 Xie, N.-H. et al. Deciphering erasing/writing/reading of near-infrared fluorophore for nonvolatile optical memory. ACS applied materials & interfaces 11, 23750-23756 (2019).
59 Adam, V. et al. Data storage based on photochromic and photoconvertible fluorescent proteins. Journal of biotechnology 149, 289-298 (2010).
60 Padgaonkar, S. et al. Light-Triggered Switching of Quantum Dot Photoluminescence through Excited-State Electron Transfer to Surface-Bound Photochromic Molecules. Nano letters 21, 854-860 (2021).
61 Zhuang, Y., Wang, L., Lv, Y., Zhou, T. L. & Xie, R. J. Optical data storage and multicolor emission readout on flexible films using deep-trap persistent luminescence materials. Advanced Functional Materials 28, 1705769 (2018).
62 Chan, E. M. et al. Combinatorial discovery of lanthanide-doped nanocrystals with spectrally pure upconverted emission. Nano letters 12, 3839-3845 (2012).
63 Lemmer, M., Inkpen, M. S., Kornysheva, K., Long, N. J. & Albrecht, T. Unsupervised vector-based classification of single-molecule charge transport data. Nature communications 7, 1-10 (2016).

1. A photo-switchable nanocrystal comprising:
solely one or more inorganic elements.

2. The nanocrystal of claim 1, wherein the one or more fully inorganic elements comprise lanthanide ion (Ln³⁺)-based phosphors.

3. The nanocrystal of claim 1, wherein the nanocrystal at least one of (i) is photostable, (ii) operates at light wavelengths that are not phototoxic, (iii) provides a photo-switch emission bidirectionally, (iv) is part of a high-density patterning system, (v) comprises a core/shell NaYF₄ ANPs with 8% Tm³⁺, or (vi) is a sub-micron crystal.

4. The nanocrystal of claim 3, wherein the nanocrystal does not photodegrade with light excitation cycles.

5-6. (canceled)

7. The nanocrystal of claim 3, wherein the bidirectional emission comprises a light and a dark nanocrystal state.

8. The nanocrystal of claim 6, wherein the excitation of the nanocrystal for the bidirectional emission occurs at near-infrared light.

9. The nanocrystal of claim 6, wherein a first photo-trigger turns the nanocrystal on, and wherein a second photo-trigger turns the nanocrystal off.

10. The nanocrystal of claim 9, wherein the first photo-trigger is near 700 nm wavelength and the second photo-trigger is near 1,064 nm wavelength.

11. (canceled)

12. The nanocrystal of claim 3, wherein the high-density patterning system comprises at least one of (i) brightening and darkening 2D patterns sequentially, or (ii) comprises fully-rewritable 3D nanopatterning.

13. (canceled)

14. The nanocrystal of claim 1, wherein the nanocrystal is part of super-resolution microscopy.

15. The nanocrystal of claim 14, wherein the nanocrystal is located via the super-resolution microscopy.

16. The nanocrystal of claim 4, wherein the light excitation cycles comprises at least one thousand cycles.

17. The nanocrystal of claim 3, wherein the nanocrystal does not photodegrade under at least one of (i) ambient conditions, or (ii) aqueous conditions.

18-19. (canceled)

20. The nanocrystal of claim 6, wherein the emission is achieve through photon avalanching.

21. The nanocrystal of claim 1, wherein the one or more inorganic elements comprise any inorganic crystal that supports photon avalanching.

22. (canceled)

23. The nanocrystal of claim 1, wherein the nanocrystal is usable in at least one of (i) an anatomical structure, or (ii) an internal unpowered medical product.

24. (canceled)

25. A method for synthesizing photo-switchable nanocrystal comprising:
utilizing solely inorganic elements.

26. The method of claim 25, wherein the one or more fully inorganic elements comprise lanthanide ion (Ln³⁺)-based phosphors.

27. The method of claim 25, wherein the nanocrystal at least one of (i) is photostable, (ii) operates at light wavelengths that are not phototoxic, (iii) provides a photo-switch emission bidirectionally, (iv) is part of a high-density patterning system, (v) comprises a core/shell NaYF₄ ANPs with 8% Tm³⁺, or (vi) is a sub-micron crystal.

28. The method of claim 27, wherein the nanocrystal does not photodegrade with light excitation cycles.

29-48. (canceled)
